(19) United States
(12) Patent Application Publication
(10) Pub. No.: US 2006/0069615 A1
(43) Pub. Date: Mar. 30, 2006

(54) Systems and methods for subsidizing the printing costs of advertiser-sponsored documents delivered through broadcast networks

(76) Inventor: Ajay Gupta, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/955,013

(22) Filed: Sep. 29, 2004

(51) Int. Cl. G06Q 30/00

(52) U.S. Cl. 705/14

(57) ABSTRACT

A method for a consumer to receive a consumer credit in exchange for the printing of an advertiser-sponsored document includes first, printing an advertiser-sponsored document, the advertiser-sponsored document having a page ID associated therewith. The advertiser-sponsored document includes supplemental content which is specific to a particular broadcast program, whereby the supplemental content is demodulated from a broadcast signal carrying the particular broadcast program. Next the page ID is forwarded to a redemption entity. Subsequently the consumer receives a consumer credit, the value of which is related to the number of printed advertiser-sponsored documents.

### CROSS-REFERENCE TO RELATED APPLICATIONS

The present invention is related to the commonly-assigned, concurrently filed patent application entitled: “Systems and Methods for Providing and Processing Print-Augmented Broadcast Signals,” the contents of which are herein incorporated by reference for all purposes.

### BACKGROUND

The systems and methods described in the commonly-assigned concurrently-filed application, describe a new system, whereby a viewer or listener (herein referred to as a consumer) can get, either in print or electronic form, supplemental content which is contemporaneous with the standard program content with little, if any, disruption to the consumer's viewing or listening experience. With this new system, it is expected that the consumer will avail him/herself of this new capability, and print, either immediately during the program or electronically download and print thereafter, a physical copy of the supplemental content, (herein referred to as an “advertised-sponsored document”) one or more times, resulting in increased printing operations.

In view of this expected increase in printing operations, there is a need to reduce the cost of printing the advertiser-sponsored documents as perceived by the consumer. While at the same time, since it is almost certain that the consumer, when he/she has printed the material, will read it, it provides an excellent opportunity to an advertiser to deliver a targeted message. Thus this desire on the part of consumer to reduce the cost of print, and the desire on the part of the advertiser to deliver a message on the print creates an environment where part of the printing cost can be “sponsored” or subsidized by the advertiser provided the consumer is willing to let a message from the advertiser be printed along with the supplemental content.

### SUMMARY

One of the disclosed processes describes a method for a consumer to receive a consumer credit in exchange for the printing of an advertiser-sponsored document. Within this process, the consumer initially prints an advertiser-sponsored document, the advertiser-sponsored document having a page ID and one or more sponsor IDs associated therewith. The advertiser-sponsored document includes supplemental content which is specific to a particular broadcast program, whereby the supplemental content is demodulated from a broadcast signal carrying the particular broadcast program. Next, the page ID is forwarded to a redemption entity. Subsequently the consumer receives a consumer credit in exchange for the printing of the advertiser-sponsored document.

These and other features of the invention will be better understood when read in view of the following drawings and detailed written description.

### BRIEF DESCRIPTION OF THE DRAWINGS

FIG. 1A illustrates a system for providing a print-augmented broadcast signal in accordance with one embodiment of the present invention.

FIG. 1B illustrates a system for receiving a print-augmented signal from which an advertiser-sponsored document may be printed in accordance with an embodiment of the present invention.

FIG. 2 illustrates a flow diagram showing a consumer credit being exchanged for the printing of an advertiser-sponsored document in accordance with an embodiment of the present invention

FIG. 3 illustrates a method for receiving a consumer credit in exchange for printing an advertiser-sponsored document in accordance with an embodiment of the present invention.

FIG. 4 illustrates a method for providing a consumer credit in exchange for printing an advertiser-sponsored document in accordance with an embodiment of the present invention.

FIG. 5 illustrates a method for facilitating the exchange of a consumer credit for the printing of an advertiser-sponsored document in accordance with an embodiment of the present invention.

### DETAILED DESCRIPTION

The present invention builds upon the systems and processes described in the related application, the present invention being directed to providing processes by which the consumer can recoup the expense or receive a credit for printing documents.

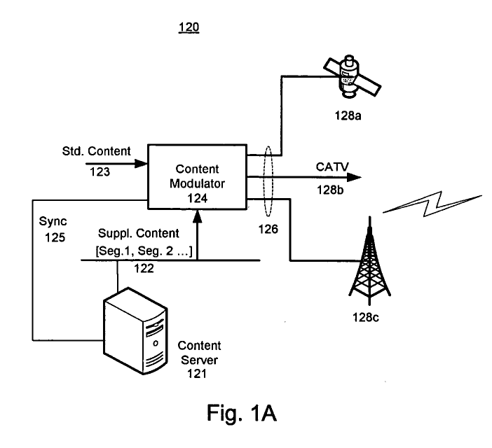

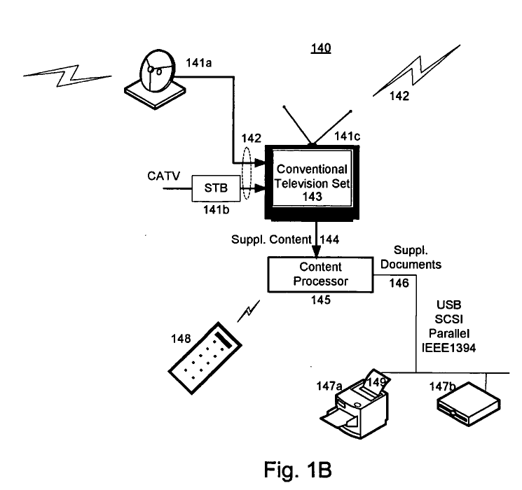

FIG. 1A illustrates a system for receiving a print-augmented signal from which an advertiser-sponsored document may be printed in accordance with an embodiment. The system is additionally described in the commonly-assigned co-pending patent application entitled “Systems and Methods for Providing and Processing Print-Augmented Broadcast Signals,” incorporated herein by reference.

The system 120 includes a content server 121, a content modulator 124 and a broadcasting means 128, which may include a satellite transmitter 128a, a cable television transmitter 128b, or a transmitting tower 128c. These transmitting systems are only exemplary, and other transmitter embodiments will be apparent to those skilled in the art.

During operation, the content modulator 124 receives an audio (radio) or an audiovisual (TV) signal that carries the standard content 123 of the broadcast program. The audio or audiovisual broadcast signal includes a non-content portion (e.g., the vertical blanking interval in analog TV signals, or the programming associated data channel in digital video television signals, etc.) onto which supplemental content may be modulated. The content modulator receives supplemental content 122, and subsequently, modulates the supplement content 122 onto the non-content portion of the broadcast signal carrying the standard content 123 to form a print-augmented broadcast signal 126. The particular modulation process employed can be any of those known in the art, and most particularly within the broadcasting arena, the modulation process used depending upon the type of broadcast and demodulation/decoding circuitry implemented in the intended receiver.

In an embodiment, the modulation process, is synchronized such that segments of the supplemental content 122 are modulated onto those vertical blanking intervals occurring on the broadcast signal portion which carries corresponding standard content. The print-augmented broadcast signal 126 retains the signal waveform of a conventional television signal (NTSC, PAL, SECAM, HDTV, etc.), and can therefore be processed by a conventional television set. The signal 126 is subsequently provided to the desired transmitting apparatus (e.g., a satellite transmitter 128a, cable television transmitter 128b, or television broadcast tower 128c) for broadcast to a multitude of conventional television sets.

FIG. 1B illustrates a system for receiving a print-augmented signal, also as described in the aforementioned related application, from which an advertiser-sponsored document may be printed. The system includes receiving means 141a-c, a conventional television set 143, a content processor 145, content output means 147, and optionally a remote control unit 148. Exemplary receiving means include a satellite receiver 141a, a set top box 141b, or television aerials 141c, each of which is adapted to convert the received signal into a received version of the print-augmented broadcast signal 142 which can be processed by the convention television set 143.

During operation, the print-augment broadcast signal 142 is received (or recovered by the receiving means 141); the received signal 142 being in the format of a broadcast signal (e.g., NTSC format for North American television sets) which can be processed by a conventional television set 143. The print-augmented signal 142 carries received versions of the standard content and the supplemental content. In a particular embodiment, the standard content and that supplemental content that is associated with that segment of the standard content are modulated on the same or adjacent portions of the broadcast signal, so that both are received substantially concurrently. Demodulation circuitry inside the conventional television set is operable to demodulate the standard content from the print-augmented signal 143 and displays the standard content on the television screen. The internal tuner of the conventional television set is further operable to demodulate the received version of the supplemental content 144, outputting it on the Video Output port of the television.

The supplemental content 144 is output to the content processor 145, which is operable to assemble the supplemental content into one or more supplement documents 146. The supplemental documents 146 can be output to a printer 147a, for example, on command by a remote control unit 148. In this manner, the viewer can download supplemental content that is associated with the currently displayed programming with little or no disruption in their viewing experience.

In a particular embodiment, the printed document 149 is an advertiser-sponsored document of the kind described herein. The advertiser-sponsored document will usually include advertisements, from one or more advertisers. In the latter manner, several advertisers can share the cost of sponsoring the particular document, the process of which is further described below. The advertisements themselves may be printed on the document in predefined areas, for example in the margin of the documents. Placement of the advertisement may be defined via meta-data which is included within the recovered supplemental content 144. The advertiser-sponsored document 149 is not limited to any particular page length, and may consist of a portion of one page, one page or several pages.

In an alternative embodiment, for example when the receiver is a television set, the advertiser-sponsored document may consist of a static, changing, or running banner that is posted on the television screen for a predetermined period of time during the particular broadcast program. In such an embodiment, the aforementioned credit, in one embodiment, towards the purchase of additional printing supplies, could be obtained as a function of the banner display time.

The cost of printing the advertiser-sponsored document is subsidized by the advertiser directly or indirectly providing a credit to the consumer (i.e., the party printing the document). The credit may take a variety of forms. For example, the credit may be in the form of a discount toward the purchase of additional printer supplies, such as a toner cartridge, printer ink, printer maintenance, additional software, etc., a credit toward the purchase of a new model printer the advertiser wishes to promote, or other related printer products. Alternatively, the credit may be used toward other items which are related to the program content, for instance, a credit toward the purchase of a video game which is associated to a viewed cartoon program, or a credit toward the purchase of tools which were shown during the broadcast program. Further alternatively, the credit may be in a form which is not related to the advertisement, for example in the form of cash or equivalent thereof. The foregoing examples represent only a few of the possible forms the consumer credit may take, and it is understood that any of such forms may be alternatively used in the present invention.

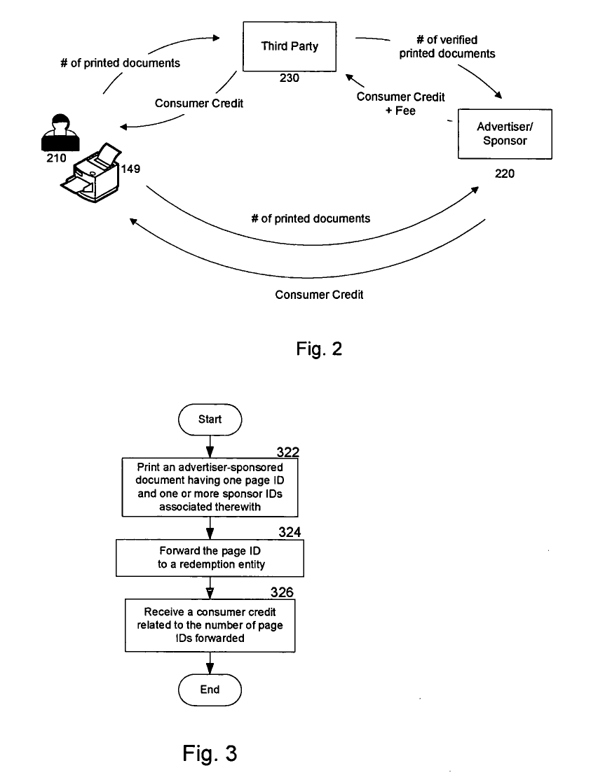

FIG. 2 illustrates a flow diagram between three possible parties involved in a process for exchanging a consumer credit for the printing of an advertiser-sponsored document 149. The three parties include a consumer 210 who prints the document 149, an advertiser or sponsor 220 who underwrites the content of the supplement content contained within the document 149 and who provide the consumer credit and possibly an additional fee, and an optional third party 230, who acts to facilitate the exchange between the consumer 210 and the advertiser 220. The optional third party 230, while not necessary, would preferably be the broadcaster that is broadcasting the program and its associated supplemented content. The broadcasters already have commercial relationships with the advertisers for the advertisements they air (interspersed with the main content). A similar relationship can be extended by offering to the advertisers space on the printable content.

The exchange, in one embodiment takes place directly between the consumer 210 and the advertiser 220, whereby the consumer communicates the number of documents 149 printed to the advertiser or sponsor, that party conveying a consumer credit back to the consumer. Such an arrangement may occur, for instance, between a video game manufacturer who underwrites the printed document 149, the consumer credit being in the form of a rebate or specific amount off the retail price of the video game. In such an embodiment, the advertiser 220 would typical verify the number of printed documents 149, the amount of the consumer credit being based upon the number of sponsored printed documents. In another embodiment, the consumer credit conveyed is based upon only the number of new sponsored documents printed, i.e., documents reprinted from the same printer are not counted toward the consumer credit. The process of verifying the number of printed documents 149, and the process of computing the document count upon which the consumer credit is based are further described below.

A second embodiment provided in FIG. 2 involves a third party 230 which operates to facilitate the exchange of the consumer credit between the consumer 210 and the advertiser sponsor 220. Such an arrangement may occur, for example, between a consumer 210 viewing a cooking show, a sponsor of the cooking show 220, and a printer equipment manufacturer operating as the third party 230. In this arrangement, the consumer communicates the number of printed documents 149 printed to the advertiser (exemplary processes of which are further described below). Once the document count is verified, a consumer credit plus an additional fee is communicated to the printer equipment manufacturer or outlet store, the consumer credit being in the form of a credit toward the purchase of additional printer equipment, and the additional fee provided to cover the costs of the third party's processing of the credit. The third party print equipment manufacturer then communicates the consumer 210 or awaits an order from the consumer to which to apply the received credit. In this manner, the consumer recovers at least some of the cost of the print, and the third party print equipment manufacturer is referred business which it may not otherwise have obtained.

FIG. 2 includes a third exchange arrangement in which the third party entity serves to exchange both the information regarding the number of printed documents 129 as well as the consumer credit conveyed to the client. Such an arrangement may be employed between a consumer 210 viewing a home improvement program, a sponsor of the home improvement program 220, and a third party entity 230 which can both verify the amount of printed documents 149 the consumer has printed, and act as a payer, perhaps of cash, to the consumer 210. In such an embodiment, the consumer supplies the third party 230 a report as to the number of documents 149 printed. The third party verifies the print count, computes the consumer credit due based thereon, and communicates the consumer credit to the advertiser 220. The advertiser 220, in turn, remits the request sum plus an additional fee for the third party's handling of the information, a portion corresponding to the consumer credit being forward to the consumer 210. The third party 230 may receive additional reports from other consumers indicating that they have printed the advertiser-sponsored documents 149. In such an instance, the third party 230 may be instructed to verify each of the reports, and compute a total sum corresponding to the consumer credits plus additional fees due for all of the reporting consumers. Once remitted by the advertiser 220, the third party 230 computes each consumer's due credit and submits it thereto.

It is noted that other embodiments are possible as well. For example, the third party may be involved in the exchange of the number of printed documents 149, but the advertiser 220 conveys the consumer credit directly to the consumer 210. It will also be understood that additional parties may be involved in the transaction as well, as a number of different variations of the exemplary embodiments shown in FIG. 2 are possible under alternative embodiments of the present invention.

The above-presented exemplary embodiments may be described in terms of three processes: (1) a process for the consumer to receive a consumer credit in exchange for printing the advertiser-sponsored document; (2) a process for the advertiser who underwrites the printed document 149 to provide a consumer credit in exchange for the document's printing; and (3) a process for facilitating the exchange of a consumer credit for the printing of an advertiser-sponsored document. Each of these processes is now described in greater detail below:

Exemplary Processes for Receiving a Consumer Credit

FIG. 3 illustrates a method for a consumer to receive a consumer credit in exchange for printing an advertiser-sponsored document. Initially at 322, the consumer prints one or more advertiser-sponsored documents, using the system (or equivalents thereof) as shown in FIG. 1B. Particularly, each of the printed documents contains supplemental content that is demodulated from a broadcast signal portion, that broadcast signal portion carrying standard program content which is substantially contemporaneous with the supplemental content.

Further, each printed document has one associated page identifier or “page ID” which is used by the advertiser and/or the third party to identify the particular page printed. In addition, one or more sponsor identifiers “sponsor ID(s)” are associated with each printed document, each sponsor ID identifying a particular sponsor of the document. There may be one or more sponsors of the same advertiser-sponsored document. Subsequently at 324, the page ID for each document printed is forwarded to a redemption entity, which may be either the advertiser/sponsor of the supplement content, or the third party entity. Next at 326, the consumer receives a consumer credit, the value of which is related to the number of page IDs forwarded as further described below.

In a particular embodiment of the forwarding process, the forwarded information includes “page ID-sponsor ID” data string, whereby the page ID identifies the particular document and the sponsor IDs identifies on of the one or more sponsors who underwrite the document. For those documents having more than one sponsor ID associated therewith, a respective number of data strings, each having the same page ID but a different sponsor ID, would be generated and forwarded.

Various modifications and additions may be implemented to further refine the process of FIG. 3. For example, the system may include a tamper-resistant memory (which may be locating in the content processor or the printer) for securely storing the page and sponsor IDs, which, at a predefined time or upon request, operates to batch downloading all of the page and sponsor IDs to the redemption entity. This process could include printing the data strings in an encrypted hash and forwarded it to the redemption entity (e.g., by mail, fax, as an attachment to an e-mail), after which the hash can be scanned and the data recovered.

Further, the number of page IDs used to compute the consumer credit may be based upon all page IDs received, or alternatively, could exclude repeat prints, since the advertiser in this case has not reached a new potential consumer. In this later instance, a printer identifier “print ID” is assigned to each printer, and the printer ID is included in the aforementioned data strings forwarded to the redemption entity. Accordingly, when a consumer reprints a page, they will have two instances of the same page ID-printer ID for a particular sponsor, which can be identified by the redemption entity. In such an instance, the consumer may receive a credit based upon the number of data strings that include a unique combination of the page ID and printer ID.

Exemplary Process for Providing a Consumer Credit

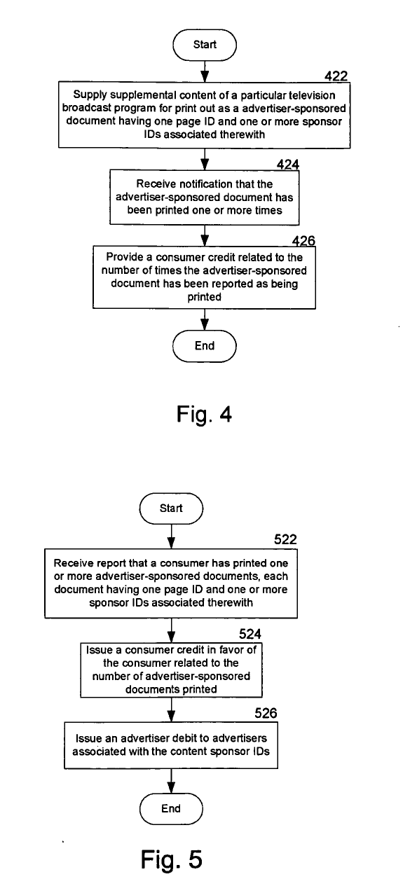

FIG. 4 illustrates a method for providing a consumer credit in exchange for printing an advertiser-sponsored document using the system (or equivalents thereof) as shown in FIG. 1A. This method generally relates to the processes by which a particular advertiser/sponsor will provide payment in exchange for receiving a notification that their sponsored document has been printed by a consumer.

Initially, at 422, supplemental content of a particular broadcast program is supplied as describe in FIG. 1A, above. Particularly, the printed document(s) contains supplemental content that is modulated onto a broadcast signal portion, that broadcast signal portion carrying standard program content which is substantially contemporaneous with the supplemental content. Further, each advertiser-sponsored printed document has an associated page identifier “page ID,” and each advertiser/sponsor who underwrites the particular printed document is identified with a sponsor identifier “sponsor ID”. In instances in which a single advertiser/sponsor underwrites the printed document, only one sponsor ID will be associated therewith. In other instances, two or more advertisers may agree to share the underwriting cost of the printed document, in which case there will be a corresponding two or more sponsor IDs associated with the printed document.

Next at 424, a notification is received by those advertisers associated with the one or more sponsor IDs that one or more advertiser-sponsored document have been printed. In a particular embodiment, the notification received includes, for each advertiser-sponsored document associated with the particular advertiser, data strings indicating the printer ID and the page ID. Further, the sponsor ID may also be included in the data string, although this information is not necessary as it can be inferred as being associated with the advertiser from the particular advertiser's receipt of the data. However, when the advertiser has obtained more than one sponsor ID (perhaps to provide to subsidiary entities), the sponsor ID could be useful to include in the data string.

Subsequently at 426, a consumer credit is provided from each of the advertisers associated with a sponsor ID, the value of which is related to the number of reported page IDs associated the particular sponsor ID. In a particular embodiment, the value of the consumer credit provided in favor of a particular consumer is based upon the total number of times that consumer has printed the document, including reprints. In another embodiment, reprints are excluded from the computation as they do not reach a new potential consumer. In this latter embodiment, the aforementioned page and printer identifiers will be the same for reprinted documents. Once identified, those documents can be excluded from the page count determining the consumer credit to be provided. The consumer credit may be made either directly to the consumer him/herself, or the consumer credit may be made in favor of the consumer and issued to another party, e.g. a printing supply retailer, from which the consumer would be entitled to a credit, e.g. towards the purchase of a new toner cartridge.

Other modifications may be employed as well in this process. For example, the method may further include a verification process, such as using a scanner (not shown) to scan an encrypted hash to decode a sequence (e.g. the data strings described herein) which indicates the number of document prints made.

Exemplary Process for Facilitating the Exchange of a Consumer Credit and/or Number of Printed Documents

FIG. 5 illustrates a method for facilitating the exchange of a consumer credit for the printing of an advertiser-sponsored document using as an exemplary bases, the flow diagram of FIG. 2. In this embodiment, a report is received by a third party that a particular consumer has printed one or more advertiser sponsored documents (process 522), each document being generated from supplemental content as recovered according to the receiver system and processes described above. Each printed document has one page ID, one printer ID, and one or more sponsor IDs associated therewith, each of the one or more sponsor IDs corresponding to a respective one or more advertisers who underwrite the cost or printing the document.

Next at 524, a consumer credit is issued in favor of the particular consumer. Subsequently at 526, an advertiser debit is issued to each of the one or more advertisers associated with the one or more sponsor IDs. Particular methods for computing the values of the consumer credit and advertiser debit, which may or may not be the same, are further described below.

The aforementioned modifications may be implemented in the processes of FIG. 5 as well. For instance, the process of receiving the report may include receiving one or more data strings: sponsor ID-page ID-printer ID, whereby the sequences are stored in a secure memory (either in the content processor of the printer itself) and printed in an encrypted hash for e-mail, facsimile or mailing to the third party.

The value of the consumer credit may be computed from the total number of pages printed associated with a particular advertiser, including reprints, or computed using only one print of the same page from the same printer. If the former computational method is used, the value of the consumer credit is computed from the total number of documents printed, or equivalently in the aforementioned embodiment, the total number of data strings reported. If the latter computation method is adopted, the value of the consumer credit issued is computed from the number of data strings that include a unique combination of the page ID, the printer ID, and the sponsor ID.

The value of the issued advertiser debit may also be determined using a variety of different computations. In one embodiment, the value of the advertiser debit is computed from the total number of printed documents (e.g., the total number of data strings received) which are associated with the particular advertiser (e.g. which are associated with the particular advertiser's sponsor ID). In another embodiment, the value of the advertiser debit is computed from the total number of associated documents printed (i.e., the advertiser's sponsor ID), but which excludes reprints (e.g. more than one data string that has the same combination of a printer ID and page ID). Further, the computations for computing the consumer credit and advertiser debit may not be the same, for example the method of computing the consumer credit may be based upon all printed documents made, while the advertiser debit may be based upon the number of unique combinations of the page, printer, and sponsor IDs. Other variations and modifications are possible as well.

As readily appreciated by those skilled in the art, the described processes may be implemented in hardware, software, firmware or a combination of these implementations as appropriate. For example, the processes of printing, scanning documents, forwarding or receiving documents and reports may be carried out by printers, scanners, telefax machines, and the like. Processes for receiving and issuing consumer credit and advertiser debits may be carried out using systems which permit electronic money transfers. In addition, some or all of the described processes may be implemented as computer readable instruction code resident on a computer readable medium (removable disk, volatile or non-volatile memory, embedded processors, etc.), the instruction code operable to program a computer of other such programmable device to carry out the intended functions.

The foregoing description has been presented for purposes of illustration and description. It is not intended to be exhaustive or to limit the invention to the precise form disclosed, and obviously many modifications and variations are possible in light of the disclosed teaching. The described embodiments were chosen in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for receiving a consumer credit in exchange for the printing of an advertiser-sponsored document, the method comprising:
printing one or more advertiser-sponsored documents, each advertiser-sponsored document having one page ID and one or more sponsor IDs associated therewith, wherein each advertiser-sponsored document comprises supplemental content which is specific to a particular broadcast program, and wherein the supplemental content is demodulated from a broadcast signal carrying the particular broadcast program;
forwarding the page ID associated with the one or more advertiser-sponsored documents to a redemption entity; and
receiving a consumer credit, the value of the consumer credit being related to the number of page IDs forwarded.

2. The method of claim 1, wherein the consumer credit received comprises a credit toward the purchase of printer equipment, and wherein the redemption entity comprises an entity which offers the printer equipment for sale.

3. The method of claim 1, wherein the value of the consumer credit received is computed from the total number of page IDs received.

4. The method of claim 1, wherein forwarding the page ID comprises forwarding, for each particular advertiser-sponsored document printed, one or more data strings, each data string comprising the page ID and one of the one or more sponsor IDs which are associated with the particular advertiser-sponsored document.

5. The method of claim 4, wherein each data string further comprises a printer ID operable to identify the printer from which the advertiser-sponsor documents are printed, and wherein forwarding the page ID comprises forwarding, for each particular advertiser-sponsored document printed, one or more data strings, each data string comprising the page ID, the printer ID and one of the one or more sponsor IDs which are associated with the particular advertiser-sponsored document.

6. The method of claim 5, wherein the value of the consumer credit received is computed from the number of data strings which have a unique combination of the page ID and the printer ID.

7. The method of claim 6, wherein the data strings are printed in an encrypted hash, and wherein forwarding comprises forwarding the encrypted hash to the redemption entity.

8. A method for providing a consumer credit in exchange for the printing of an advertiser-sponsored document, the method comprising:
supplying supplemental content of a particular broadcast program for print out as an advertising-sponsored document, the advertiser-sponsored document having one page ID and one or more sponsor IDs associated therewith, the supplement content intended for modulation onto a broadcast signal carrying the particular broadcast program;
receiving a notification that the advertising-sponsored document has been printed one or more times; and
providing a consumer credit, the value of the consumer credit related to the number of times the advertiser-sponsored document has been reported as being printed.

9. The method of claim 8, wherein the received notification comprises, for each particular advertiser-sponsored document printed, one or more data strings, each data string comprising the page ID and one of the one or more sponsor IDs associated with the particular advertiser sponsored document.

10. The method of claim 9, wherein each of the data string further comprises a printer ID operable to identify the printer from which each advertised-sponsored document were made.

11. The method of claim 10, wherein the value of the consumer credit is computed from the total number of data strings received which include a particular sponsor ID.

12. The method of claim 11, wherein the value of the consumer credit is computed from the total number of data strings received which include (i) a particular sponsor ID, and (ii) a unique combination of the page ID and the printer ID.

13. A method for facilitating the exchange of a consumer credit for the printing of an advertiser-sponsored document, the method comprising:
receiving a report that a particular consumer has printed one or more advertiser-sponsored documents, each of the one or more advertiser-sponsored documents comprising supplemental content of a particular broadcast program which has been demodulated from a broadcast signal carrying the particular broadcast program, each of the advertiser-sponsored documents having one page ID and one or more sponsor IDs associated therewith, each of the one or more sponsor IDs identifying an advertiser who sponsors the advertiser-sponsored document, the report including:
a printer ID operable to identify the printer from which physical copies of the advertised-sponsored document were printed; and
a list of one or more sponsor IDs; and
issuing a consumer credit in favor of the particular consumer, the value of the consumer credit related to the number of advertised-sponsored documents printed by the particular consumer.

14. The method of claim 13, wherein the received report comprises, for each particular advertiser-sponsored document printed, one or more data strings, each data string comprising the page ID, the printer ID, and one of the one or more sponsor IDs associated with the particular advertiser sponsored document.

15. The method of claim 14, wherein the value of the consumer credit is computed from the total number of data strings received from the particular consumer.

16. The method of claim 14, wherein the value of the consumer credit is computed from the total number of data strings received which include a unique combination of the page ID, sponsor ID, and the printer ID.

17. The method of claim 16, further comprising issuing, for each sponsor ID received, an advertiser debit to a particular advertiser associated with the sponsor ID.

18. The method of claim 17, wherein the received report comprises, for each particular advertiser-sponsored document printed, one or more data strings, each data string comprising the page ID, the printer ID, and one of the one or more sponsor IDs associated with the particular advertiser sponsored document.

19. The method of claim 18, wherein the value of the advertiser debit is computed from the total number of data strings received which includes the sponsor ID associated with the particular advertiser.

20. The method of claim 18, wherein the value of the advertiser debit is computed from the total number of data strings received which include (i) the sponsor ID associated with the particular advertiser and (ii) a unique combination of the page ID and the printer ID.

21. A system operable to receive a consumer credit in exchange for the printing of an advertiser-sponsored document, the system comprising:
a printer operable to print one or more advertiser-sponsored documents, each advertiser-sponsored document having one page ID and one or more sponsor IDs associated therewith, wherein each advertiser-sponsored document comprises supplemental content which is specific to a particular broadcast program, and wherein the supplemental content is demodulated from a broadcast signal carrying the particular broadcast program;
means for forwarding the page ID associated with the one or more advertiser-sponsored documents to a redemption entity; and
means for receiving a consumer credit, the value of the consumer credit being related to the number of page IDs forwarded.

22. The system of claim 21, wherein each data string further comprises a printer ID operable to identify the printer from which the advertiser-sponsor documents are printed, and wherein the means for forwarding the page ID comprises means for forwarding, for each particular advertiser-sponsored document printed, one or more data strings, each data string comprising the page ID, the printer ID and one of the one or more sponsor IDs which are associated with the particular advertiser-sponsored document.

23. A system operable to provide a consumer credit in exchange for the printing of an advertiser-sponsored document, the system comprising:
a content server operable to provide supplemental content of a particular broadcast program for print out as an advertising-sponsored document, the advertiser-sponsored document having one page ID and one or more sponsor IDs associated therewith, the supplement content intended for modulation onto a broadcast signal carrying the particular broadcast program;
means for receiving a notification that the advertising-sponsored document has been printed one or more times; and
means for providing a consumer credit, the value of the consumer credit related to the number of times the advertiser-sponsored document has been reported as being printed.

24. A system operable to facilitating the exchange of a consumer credit for the printing of an advertiser-sponsored document, the system comprising:
means for receiving a report that a particular consumer has printed one or more advertiser-sponsored documents, each of the one or more advertiser-sponsored documents comprising supplemental content of a particular broadcast program which has been demodulated from a broadcast signal carrying the particular broadcast program, each of the advertiser-sponsored documents having one page ID and one or more sponsor IDs associated therewith, each of the one or more sponsor IDs identifying an advertiser who sponsors the advertiser-sponsored document, the report including:
a printer ID operable to identify the printer from which physical copies of the advertised-sponsored document were printed; and
a list of one or more sponsor IDs; and
means for issuing a consumer credit in favor of the particular consumer, the value of the consumer credit related to the number of advertised-sponsored documents printed by the particular consumer.

25. The system of claim 24, wherein the report includes, for each particular advertiser-sponsored document printed, one or more data strings, each data string comprising the page ID, the printer ID, and one of the one or more sponsor IDs associated with the particular advertiser sponsored document.

26. The system of claim 25, further comprising means, coupled to the means for receiving the report, for verifying the authenticity of the notification.

27. The method of claim 26, wherein the received report comprises an encrypted hash which includes the one or more data strings, the system further comprising a scanner coupled to receive the report and operable to scan the encrypted hash to recover the one or more data strings.

28. A computer program product, resident on a computer readable medium, which is operable to execute instruction code for controlling a system to receive a consumer credit in exchange for the printing of an advertiser-sponsored document, the computer program product comprising:
instruction code to print one or more advertiser-sponsored documents, each advertiser-sponsored document having one page ID and one or more sponsor IDs associated therewith, wherein each advertiser-sponsored document comprises supplemental content which is specific to a particular broadcast program, and wherein the supplemental content is demodulated from a broadcast signal carrying the particular broadcast program;
instruction code to forward the page ID associated with the one or more advertiser-sponsored documents to a redemption entity; and
instruction code to receive a consumer credit, the value of the consumer credit being related to the number of page IDs forwarded.

29. A computer program product, resident on a computer readable medium, which is operable to execute instruction code for controlling a system to provide a consumer credit in exchange for the printing of an advertiser-sponsored document, the computer program product comprising:
instruction code to provide supplemental content of a particular broadcast program for print out as an advertising-sponsored document, the advertiser-sponsored document having one page ID and one or more sponsor IDs associated therewith, the supplement content intended for modulation onto a broadcast signal carrying the particular broadcast program;
instruction code to receive a notification that the advertising-sponsored document has been printed one or more times; and
instruction code to provide a consumer credit, the value of the consumer credit related to the number of times the advertiser-sponsored document has been reported as being printed.

30. A computer program product, resident on a computer readable medium, which is operable to execute instruction code for controlling a system to facilitating the exchange of a consumer credit for the printing of an advertiser-sponsored document, the computer program product comprising:
instruction code to receive a report that a particular consumer has printed one or more advertiser-sponsored documents, each of the one or more advertiser-sponsored documents comprising supplemental content of a particular broadcast program which has been demodulated from a broadcast signal carrying the particular broadcast program, each of the advertiser-sponsored documents having one page ID and one or more sponsor IDs associated therewith, each of the one or more sponsor IDs identifying an advertiser who sponsors the advertiser-sponsored document, the report including:
a printer ID operable to identify the printer from which physical copies of the advertised-sponsored document were printed; and
a list of one or more sponsor IDs; and
instruction code to issue a consumer credit in favor of the particular consumer, the value of the consumer credit related to the number of advertised-sponsored documents printed by the particular consumer.
